(19) United States
(12) Patent Application Publication
(10) Pub. No.: US 2009/0049933 A1
(43) Pub. Date: Feb. 26, 2009

(54) Automatic pipetting device for ensuring the traceability of a performed analysis

(75) Inventors: Dominique Decaux, Chaponost (FR); Bernard Limon, Rignat (FR); Frederic Paulhet, Blyes (FR)

Correspondence Address: OLIFF & BERRIDGE, PLC, P.O. BOX 320850, ALEXANDRIA, VA, 22320-4850, US

(73) Assignee: BIOMERIEUX, MARCY L'ETOILE (FR)

(21) Appl. No.: 11/921,553

(22) PCT Filed: Jun. 30, 2006
(86) PCT No.: PCT/FR2006/001543

§ 371 Date: Sep. 17, 2008

(30) Foreign Application Priority Data
Jul. 1, 2005 (FR) 0552010

(51) Int. Cl. G01N 1/14

(52) U.S. Cl. 73/863.01

(57) ABSTRACT

The present invention relates to a device for automatic pipetting of a liquid specimen, essentially comprising:
a) at least one means for sampling-dispensing the liquid specimen;
b) at least one compartment for receiving the liquid specimen, intended to receive all or part of the liquid specimen sampled by said sampling-dispensing means;
c) at least one data acquisition means;
d) at least one data processing means integrated within said pipetting device and/or delocalized, able to process the data acquired by the data acquisition means;
e) at least one means for communication between the pipetting device and a data retrieval device, said communication means being able to transfer the data between said data acquisition means and said data processing means, when the latter is delocalized; and
f) at least one power supply means;
   the data acquisition means being a means for identifying the liquid specimen and/or the container or containers intended to receive all or part of said liquid specimen.

The technical field of the present invention is that of pipetting devices or automatic pipettes. More particularly, the present invention relates to an automatic pipette, of the type of those used in biological analyses, comprising integrated means intended to make the transfer of the specimens between various containers secure and to ensure the traceability of said analyses.

The field of diagnosis, in particular medical diagnosis, is perpetually evolving both as regards modernization of technologies, and the constraints which are imposed on laboratories in terms of transparency. Though it is true that this modernization has a direct and positive influence on transparency, in particular by limiting human intervention, one is forced to note that the latter always turns out to be necessary. Specifically, though biological analysis protocols are increasingly automated, it is nonetheless still the case that a human must intervene at least to dispense the specimens into the analysis apparatuses. This indispensable step can constitute a not inconsiderable source of errors.

Specifically, since automatons generally carry out analyses on several specimens simultaneously, it may happen that the person handling the specimens so as to dispense them into the apparatus, mixes them up. It may also happen that the operator technician does not assign the right analysis reagent to the right specimen. Thus, it may happen that the test carried out on the specimen is not that requested initially.

This entails a significant risk of error in the results, which may have dramatic consequences for patients.

Another drawback inherent in these handling steps is that when the technician handles the specimens with a view to an analysis, he does not have any process for monitoring and validating the handling actions carried out. It follows from this that if the operator makes an error, he has no means of realizing it.

Systems for identifying specimens have been put in place. Such is the case for example with barcode systems. Specifically, an identification code is allotted to each new specimen while it is being dealt with in the laboratory. A barcode tag is generally stuck to the container of the specimen. The barcode is read thereafter by the technician when handling the specimen, for the purpose of identifying the latter.

However, the risk of error remains, despite this identification system. Specifically, the technician is not safeguarded from placing the specimen in the wrong receptacle of the apparatus, although the specimen has been identified correctly by reading the barcode.

It follows that, outside of the operations carried out directly by the automaton, no means exists for monitoring and validating the various manual operations carried out by the person dealing with the analysis, this being so a fortiori when they follow one another, such as when carrying out dilutions or aliquots.

Another important source of errors, when handling the specimens, can be related to the volumes sampled. Specifically, as already mentioned above, it is not uncommon to be compelled to carry out dilutions or aliquots of specimens. Accordingly, it is necessary to sample a determined volume of said specimens. Though on the pipetting devices used today, it is generally possible for the volume that is to be sampled to be adjusted beforehand, there is nonetheless still a risk that the operator may make an error when determining the volume to be sampled. If such an error occurs, the results obtained will be incorrect, with the known consequences.

It is therefore important to be able also to monitor the volumes sampled during the dilution or aliquoting operations and to be able to validate these volumes or, at least, to be able to record the item of information on the sampled volumes, for traceability purposes.

It emerges from this state of affairs that there does not exist, to date, any manual system for pipetting specimens which makes it possible to monitor the origin of the sampled specimen, to identify the destination container of said specimen, to validate the various pipetting steps by authorizing or prohibiting sampling and/or dispensing. Neither does there exist any system for manual pipetting of specimens making it possible to automatically manage the liquid volumes (specimens, buffers or reagents) to be sampled as a function of the type of analysis carried out.

In view of the problems raised by the prior art considered above, one of the essential objectives of the present invention is to provide a device for automatic pipetting of a specimen, usable by an operator, making it possible to achieve complete traceability of the analysis performed, by recording the data related to the various containers receiving the specimen, during the pipetting operations.

Another essential objective of the present invention is to provide a device for automatic pipetting of a specimen, usable by an operator, able to verify and validate the pipetting steps.

Another objective of the present invention is to provide a device for automatic pipetting of a specimen, usable by an operator, able to assist the latter during the pipetting steps, in particular by indicating to him or by pre-adjusting the volume of the liquids (specimens, buffers and/or reagents) to be pipetted, as a function of the analysis to be performed.

Another objective of the present invention is to provide a device for automatic pipetting of a specimen able to communicate with an analysis automaton.

These objectives, among others, are achieved by the present invention which relates firstly to a device for automatic pipetting of a liquid specimen, comprising:
a) at least one means for sampling-dispensing the liquid specimen;
b) at least one compartment for receiving the liquid specimen, intended to receive all or part of the liquid specimen sampled by said sampling-dispensing means;
c) at least one data acquisition means;
d) at least one data processing means, integrated within said pipetting device and/or delocalized, able to process the data acquired by the data acquisition means;
e) at least one means for communication between the pipetting device and a data retrieval device, said communication means being able to transfer the data between said data acquisition means and said data processing means, when the latter is delocalized; and
f) at least one power supply means;
   the data acquisition means being a means for identifying the liquid specimen and/or the container or containers intended to receive all or part of said liquid specimen.

Sampling is understood to imply any operation consisting in sucking up all or some of a specimen contained in a source container, with the aid of the pipetting device according to the invention.

Dispensing is understood to imply any operation consisting in expelling all or some of the volume of the specimen contained in the pipetting device's reception compartment, once sampled.

Identification means is understood to imply any means able to make it possible to determine the origin and/or the destination of a specimen or to identify the container intended to receive said specimen.

Data retrieval device is understood to imply any means able to save, analyze and/or retrieve the data acquired by the pipetting device. Such a device can, for example, be an independent computer, a computer connected to an analysis automaton, the analysis automaton itself or else a printer.

Data processing means is understood to imply any means endowed with artificial intelligence, such as a microcontroller or a microprocessor. By way of microcontroller may be cited components of the DSP (Digital Signal Processor), FPGA (Field Programmable Gate Array) or ASIC (Application Specific Integrated Circuit) type.

Delocalized data processing means is understood to imply any data processing means disposed outside of the pipetting device. More particularly, such data processing means are an integral part of data retrieval devices, described above.

According to an advantageous variant of the invention, the pipetting device furthermore comprises at least one data storage means. Such a storage means can consist of any magnetic or digital means, widely employed in the field of computing and well known to the person skilled in the art. More particularly, the data storage means can advantageously be a nonvolatile memory of the EEPROM or Flash type, so that the data contained in said storage means are not erased in the case where the pipetting device according to the invention is no longer energized.

According to a particular embodiment, the communication means integrated within the pipetting device according to the invention, is a wire-based connection means.

Wire-based connection means is understood to imply any means making it possible to connect two electronic devices together, so as to allow the transmission of data. In particular, a wire-based connection means can be a connection system of serial type (RS 485, RS 232 standard), of USB type (Universal Serial Bus), of network type (Ethernet), of parallel type (GPIB) or any other equivalent means.

According to a preferential variant embodiment, the device comprises a wireless communication means. Advantageously, this wireless communication means is a device for sending-receiving radioelectric waves. It may for example be a Wifi (802.11b standard), Bluetooth (802.15 standard) or else ZigBee (802.15.4 standard) system.

A suitable Bluetooth module can be that marketed by the company National Semiconductor, under the reference LMX9814 or that marketed by the company Socket Communications under the reference Kwikblue SMD.

A suitable ZigBee module can be one of those marketed by the company Freescale Semiconductor, Inc, in the MC13 series.

An alternative consists in using an infrared transmission means.

The pipetting device according to the invention can also comprise at least one information display means. This information display means can consist of one or more electroluminescent diodes, in its simplest version. According to this embodiment, the diodes can provide the operator carrying out the analysis with various information, in particular related to the acquisition of the data, the identification of the container holding the liquid specimen or intended to receive it. The information display means is however more preferably a liquid crystal screen.

According to a preferential embodiment of the pipetting device according to the invention, the data acquisition means is an image acquisition means.

Image acquisition means is understood to imply any means able to provide an image of sufficient quality to be able to be analyzed. Such a means can be for example an opto-electronic sensor of the CCD or CMOS type. Such a means is generally combined with a data shaping means intended to enable the data to be dealt with and transferred.

According to an alternative, the data acquisition means can be an RFID (Radio Frequency Identification) reader.

According to another preferential embodiment, the means for sampling-dispensing the liquid specimen has a variable sampling capacity.

Variable sampling capacity is understood to imply a sampling capacity that can be adjusted on demand.

Advantageously, the sampling-dispensing means is of syringe type, comprising a body and a piston, said piston being propelled by an actuation means.

Actuation means is understood to imply any means suitable for propelling the piston of the syringe in a longitudinal translational movement inside the body of the syringe. Such an actuation means can be for example an electric, electromagnetic, electropneumatic means, or any other equivalent means. It may advantageously be a motor of the stepper type.

According to another variant of the invention, the pipetting device according to the invention can also comprise a means for determining the angle of inclination of said device, during the implementation of said device. This may, for example, be an accelerometer or a gyroscope.

Preferably, the device according to the invention comprises a compartment for receiving the liquid specimen which can be detached from said device. More preferably still, said compartment is a disposable tip.

Disposable tip is understood to imply any single-use device, which can be fitted to the end of a pipetting device so as to be in fluidic communication with the latter. In particular, such a disposable tip generally takes the form of a frustoconical reservoir made of plastic. The capacity and composition of this disposable tip can differ according to the use envisaged.

In a preferential manner, the power supply means of the pipetting device according to the invention is a rechargeable means of the battery type. More preferably still, this battery is of large capacity so as to allow the pipetting device according to the invention to operate for several hours without being recharged. Of course, a support of the pipetting device is advantageously envisaged with integrated battery charger. Alternatively, the battery charger can be independent of the support of the pipetting device.

Another object of the present invention relates to the use of a pipetting device such as defined above, for carrying out an analysis of a biological specimen.

Another object of the present invertion relates to a method of sampling a liquid specimen, disposed inside a source container, with the aid of the pipetting device such as defined above, comprising the steps consisting in:
a) acquiring the identification data disposed on said source container, with the aid of the data acquisition means; and
b) sampling a determined volume of liquid specimen, with the aid of the sampling-dispensing means, in such a way that the volume of specimen sampled lies inside the compartment for receiving the liquid specimen.

Another object of the present invention relates to a method of dispensing into a destination container, a liquid specimen contained in the compartment for receiving the liquid specimen of the pipetting device, according to the invention. Said method comprises the steps consisting in:
a) acquiring the identification data disposed on said destination container, with the aid of the data acquisition means; and
b) dispensing into said destination container, all or some of the volume of liquid specimen contained in the reception compartment, with the aid of the sampling-dispensing means.

According to a variant of the sampling and dispensing methods described above, steps a) and b) are carried out simultaneously.

According to a second variant, of the sampling and dispensing methods described above, step b) is carried out prior to step a).

The sampling method can advantageously comprise an additional step of identifying the source container, consisting in:
transmitting the acquired data to the data processing system; and
comparing the transmitted data with a reference database, comprising identification data;
   said additional step being able to be carried out before or after the sampling step b).

According to a still more advantageous variant, the sampling method comprises an additional step a′) of validating the sampling step consisting in:
transmitting the data acquired to the data processing system,
comparing the transmitted data with a reference database, comprising identification data, by way of the data processing means, and
transmitting the sampling order to the sampling-dispensing means, when the source container has been correctly identified.

In a preferential manner, the volume of liquid specimen to be sampled is determined by the data processing means.

According to an advantageous variant, the dispensing method comprises an additional step of identifying the destination container, consisting in:
transmitting the data acquired to the data processing system; and
comparing the transmitted data with a reference database, comprising identification data;
   said additional step being able to be carried out before or after the dispensing step b).

According to a still more advantageous variant, the dispensing method comprises an additional step a′) of validating the dispensing step consisting in:
transmitting the data acquired to the data processing system,
comparing the transmitted data with a reference database, comprising identification data, by way of the data processing means, and
transmitting the dispensing order to the sampling-dispensing means, when the destination container has been correctly identified.

In a preferential manner, the volume of liquid specimen to be dispensed is determined by the data processing means.

In the sampling or dispensing methods described above, the steps consisting in:
transmitting the data acquired to the data processing system,
transmitting the sampling order to the sampling-dispensing means, and/or
transmitting the dispensing order to the sampling-dispensing means,
   are preferably carried out by way of the communication means, when the data processing means is delocalized.

Finally, another object of the present invention relates to a method of biological analysis which comprises at least one step consisting in the sampling method and/or at least one step consisting in the dispensing method, such as described above.

The aims and advantages of the present invention will be better understood in the light of the detailed description which follows, given with reference to the drawing in which:

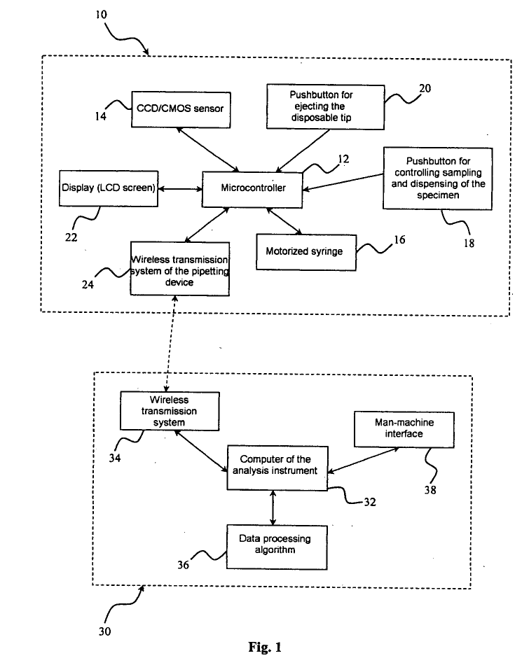

FIG. 1 represents a diagram, in the form of functional blocks, of the pipetting device according to a particular embodiment, operating in conjunction with an analysis automaton.

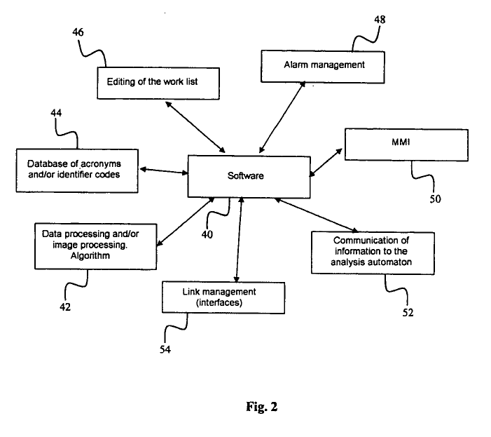

FIG. 2 represents a diagram in the form of functional blocks of the software associated with the pipetting device according to the invention.

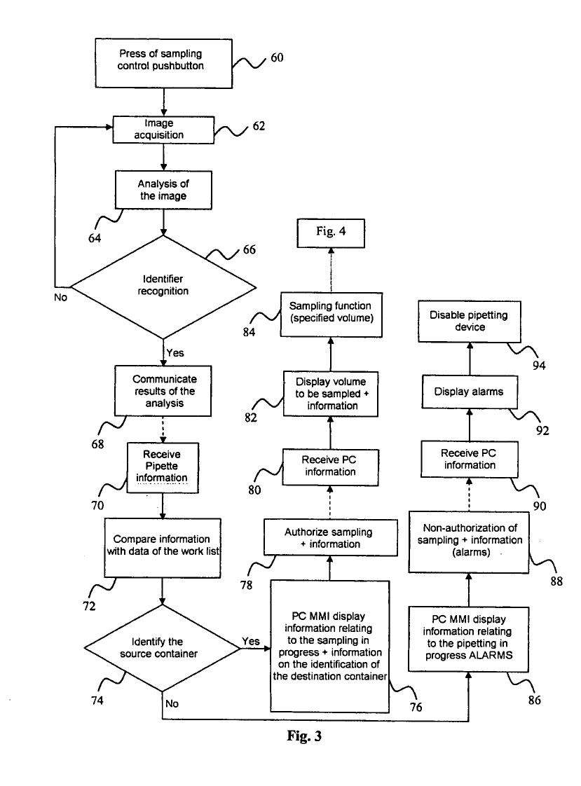

FIG. 3 represents the flowchart of a method of sampling a liquid specimen, with the aid of the pipetting device according to the invention.

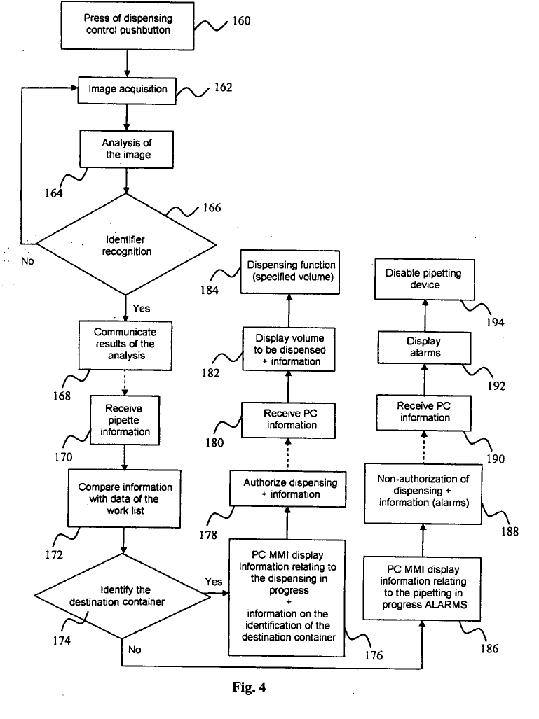

FIG. 4 represents the flowchart of a method of dispensing a liquid specimen, with the aid of the pipetting device according to the invention.

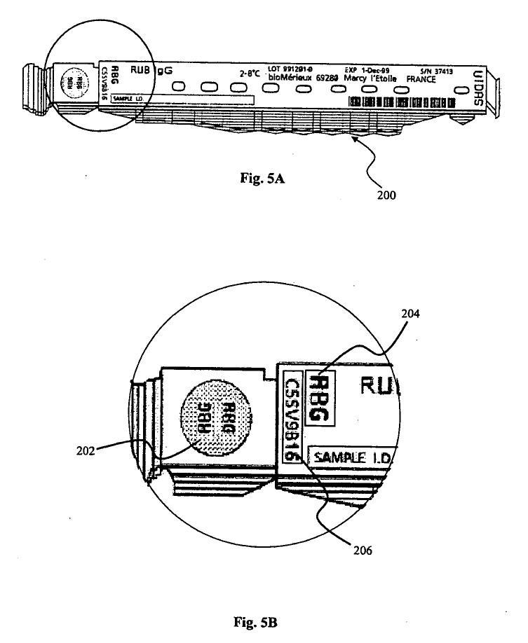

FIG. 5A represents a perspective view of an analysis cartridge used in the VIDAS® analysis automaton.

FIG. 5B represents a magnified view of an end of the cartridge represented in FIG. 5A.

An embodiment of the pipetting device is represented in FIG. 1 in the form of functional and relational blocks. According to this embodiment, the pipetting device 10 is connected to an analysis automaton 30. Indeed, the pipetting device is under the control of the analysis automaton, for the pipetting steps which will be carried out by the operator, prior to the analysis or possibly in the course of the analysis carried out by the analysis automaton.

Such an analysis automaton can be, for example and in a wholly nonlimiting manner, the VIDAS® or mini VIDAS® immuno-essays automaton, marketed by the Applicant.

The pipetting device 10 consists mainly of a microcontroller 12 whose function is to process the data related to the analysis. Thus, this microcontroller 12 allows the link between all the components of the pipetting device 10. Another function of the microcontroller 12 is to process all or some of the data acquired by the data acquisition means.

In the present case, the data acquisition means consists of a CCD or CMOS sensor 14. This sensor must allow the acquisition of images of sufficient quality to utilize identifiers, such as barcodes, alphanumeric codes, acronyms or color-codes. The sensor can be an integral part of a camera. In this respect, suitable products can be those marketed by the companies Vision Components (VCSBC50 intelligent OEM camera), I2S (OEM-D640) or OVT (CMUcam2).

The sensor is associated with an optical system (lenses) for covering the field of vision necessary for reading the identifiers. Such an optical system can advantageously be liquid optical lenses with electrically tunable focal length, such as those marketed by the company Varioptic.

A lighting system can be envisaged to ensure sufficient and constant contrast of the photos acquired. Thus this system can be a lighting system in the visible, such as a flashlamp. It may also be a lighting system in the non-visible, such as an infrared system. This lighting system can operate in continuous mode during the image acquisition phase or in pulse mode just for the image capture time so as to limit the energy expenditure.

The image acquisition device can be positioned on the pipetting device near the bottom of the latter, so that, when the pipetting device is positioned in the source or destination container with the aim of sampling or dispensing, it may be able to capture the image of the identification means, or identifier, disposed on said source or destination container.

According to a variant embodiment, the pipetting device can comprise several image acquisition devices. Thus, in addition to the image acquisition device described above, another image acquisition device can be positioned near the top of the pipetting device, in the vicinity of the area for gripping said device, so that it is able to acquire an image of the identifier of a container positioned in a substantially vertical plane, in front of the pipetting device. Specifically, such an embodiment can facilitate the identification of certain containers whose dimensions are too small to allow the acquisition of the image of the identification means, during the sampling or dispensing step, when the pipetting device is positioned plumb with the container.

In addition to these image acquisition devices, the pipetting device can advantageously be equipped in addition with a device for reading barcodes, when the image acquisition device or devices do not offer this functionality. Specifically, the recognition of barcodes by way of a sensor, generally requires that the latter exhibit high performance so that the recognition can be carried out under good conditions. This may represent a significant cost. In which case, it may be preferable to use a traditional barcode reader device to perform this task, it then being possible for the built-in image acquisition sensor or sensors to exhibit lesser performance and therefore to be less expensive.

Another member of the pipetting device, driven electronically by the microcontroller 12, is the motorized syringe 14. Such a syringe can be for example of the type of those marketed by the company Biohit, under the brand eLINE®. To this syringe is added the disposable tip which plays the role of compartment for receiving the liquid specimen. When the pipetting device is used in a sampling step, the microcontroller transmits the orders to the pipette as regards the volume of specimen to be sampled. Likewise, when the pipetting device is used in a dispensing step, namely when the disposable tip contains the sampled liquid specimen, the microcontroller transmits the orders to the pipette as regards the specimen volume to be dispensed. It is recalled that the volumes sampled and dispensed can vary according to the information transmitted by the microcontroller. Likewise, the capacity of the motorized pipette can vary. Specifically, the company Biohit markets eLINE® pipettes, whose sampling capacity can range from 0.1 to 5000 μl, depending on the model.

The motorized pipette, for its part, is able to transmit to the microcontroller information relating to its operating state, such as the position of the piston, the state of the travel stops or information related to the differential pressure detectors described hereinafter. Advantageously, it is possible to arrange on the motorized pipette, a means for monitoring the liquid volume contained in the disposable tip or for plugging said disposable tip. Such a means consists of a tube in communication, via one of its ends, with the interior environment of the tip and is connected, via the other end, to a differential pressure detector. Such a detector is then able to provide a signal to the microcontroller corresponding to a change of pressure inside the disposable tip due to the filling or to the emptying of said tip or possibly to the plugging of the latter.

In the embodiment described in FIG. 1, the function of some of the constituent elements of the pipetting device is essentially to play the role of intermediary between the pipetting device and the operator, as regards the orders given by the latter. These elements are the pushbutton 18 for controlling sampling and dispensing of the specimen and the button for ejecting the disposable tip 20.

The steps of sampling and dispensing the specimen are advantageously controlled by virtue of a single pushbutton 18. Alternatively, the pipetting device according to the invention has two control pushbuttons: one to control sampling and one to control dispensing. This or these pushbuttons are also linked with the microcontroller since any press of this or these buttons is recognized by the microcontroller which then gives the order to the motorized pipette 16 to carry out a sampling or expulsion movement.

The pushbutton for ejecting the disposable tip 20 is also connected to the microcontroller. It follows that when the operator presses this pushbutton, the microcontroller gives the order to the motorized pipette 16 to eject the disposable tip. If, by this action, the microcontroller records that the disposable tip has indeed been ejected, this in no way constitutes a sufficient procedure to ensure that the ejected tip has indeed been disposed of and will not be reused.

According to an alternative of the invention, the pipetting device comprises a single pushbutton, intended to control sampling, dispensing and ejection of the disposable tip. This alternative is envisageable insofar as the microcontroller is capable of determining at each instant the state of progress of the pipetting procedure. Thus, when the specimen sampling order has been given by the microcontroller to the motorized pipette, a new press of the pushbutton by the operator is interpreted by the microcontroller as an order for dispensing all or some of the specimen contained in the disposable tip. Likewise, when the envisaged dispensing operation or operations have been performed, a new press of the pushbutton by the operator is interpreted by the microcontroller as an order for ejecting the disposable tip.

An alternative embodiment consists in having a mechanical ejection pushbutton, not controlled by the microcontroller.

According to a particular embodiment, it can therefore be envisaged that the motorized pipette has a means of ensuring the traceability of the disposable tip. For this purpose, it is possible to put in place a system for discriminating between brand new disposable tips and those that have been used, so that when a brand new disposable tip must be used and such is not the case, the microcontroller is informed thereof by the motorized pipette, and the operator is in turn informed thereof by the microcontroller, by appropriate means.

Another constituent element of the pipetting device described in FIG. 1 relates to the display device 22. According to a preferential embodiment, this display device consists of a liquid crystal screen, which exhibits the advantage of being fairly compact. This display device 22 makes it possible to communicate to the user information on the current pipetting operations such as the identification of the sampled specimen, the identification of the destination container, the possible alarms such as those related to the use of a used tip. It can also allow the operator to verify a picture taken by way of the sensor 14. The display device 22 is managed by the microcontroller 12 to which it is connected.

Finally, the last element constituting the pipetting device 10 described in FIG. 1 is the wireless transmission system 24. This mode of data transmission represents a preferential embodiment. Specifically, according to this embodiment, the pipetting device according to the invention is connected to the analysis automaton 30, more particularly to the computer 32 of said automaton 30. Such an embodiment makes it possible to ensure continuous and total traceability of the steps of the analysis carried out directly by the operator with the aid of the pipetting device and of the steps carried out by the automaton. It is thus advantageous that the analysis automaton be informed by the pipetting device of errors made by the operator during the pipetting operations.

The wireless transmission system of the pipetting device 10 is linked to the wireless transmission device 34 of the computer 32 of the analysis automaton 30 and thus allows the connection between the pipetting device 10 and the latter.

This wireless transmission device 34 can be in a preferential manner, a Wifi network card (802.11b standard), Bluetooth card (802.15 standard) or ZigBee card (802.15.4 standard), connected to the mother board of the computer 32.

According to an alternative to this transmission mode, it is also possible to connect the pipetting device 10 to the automaton by virtue of a wire-based means of data transfer. Such a wire-based transfer means has already been described above.

By virtue of this data transmission system, the computer 32 is able to process the data transmitted by the pipetting device. All or part of these data is processed by the data processing algorithm 36, in particular in terms of identifying the specimens and containers, management of errors, progress of the sampling and dispensing steps in the analysis method. Part of the identification data processed by the processing algorithm 36 is provided to the operator by way of the man-machine interface (MMI) 38. This interface allows the operator to follow the progress of the analysis. It is also through this expedient that the analysis automaton provides the operating instructions to the operator. In the event of handling error, this interface also makes it possible to provide the necessary information to the operator.

FIG. 2 shows the architecture of the software making it possible to operate the pipetting device. As may be seen, the software 40 developed specifically for the pipetting device, allows the processing of the data or the processings of the images by way of the algorithm developed with this aim. It also allows the management of the database 44 of the acronyms and/or of the identification codes, such as the barcodes, the RFID tags, the alphanumeric codes or the color-codes, which is used for identifying the data acquired by the pipetting device.

Specifically, when the operator performs a data or image acquisition with the aid of the pipetting device, these data and/or this image are dealt with by the microcontroller and transmitted to the analysis automaton. The software then also compares the data and/or image obtained from the analysis device with the database 44 of the acronyms and/or of the identification codes. It furthermore comprises a module 46 for editing the work list, which is specific to each analysis. It moreover comprises a management module 48 for the various alarms intended to forewarn the operator of any problem such as incorrect handling, the non-recognition of the identifier of a container, the use of the wrong container, etc. An important module of this software is the man-machine interface (MMI) 50, which constitutes the tie between the operator and the pipetting device and/or the computer of the analysis automaton. Another very important module consists of the module linking to the analysis automaton (52), which ensures the link between the latter and the pipetting device. Finally, the last module of the software relates to the management of the interfaces. The latter module makes it possible to ensure the linking of the various modules previously cited, by adapting in particular their communication protocol.

The data processing algorithm 36 and the database 44 of the acronyms and/or of the identification codes can be updated by the user. Specifically, it is important to be able to supplement the algorithm with new functionalities, related to the upgrading of the services that the pipetting device is required to provide. Likewise, the database of the acronyms and/or identification codes must also be able to be incremented if new identification means come to be used.

In the case where the data processing algorithm and the database of the acronyms and/or identification codes are loaded in the memory of the pipetting device, their updating is performed by way of the computer 32, via the wire-based or wireless data transmission system.

Additionally, it should be noted that the database of the acronyms and/or identification codes can be created from scratch or incremented with the aid of the pipetting device itself. Specifically, in this case, the acquisition of the data such as the capturing of images, is performed by virtue of the data acquisition device or devices of the pipetting device. Thus, it is advantageous to acquire several images of the acronyms and/or identification codes, at several angles of inclination of the pipetting device. The database of the acronyms and/or identification codes then comprises for one and the same acronym or identification code, several images intended to be used as reference data and compared with the image acquired during the use of the pipetting device.

The various steps of the method of sampling a liquid specimen with the pipetting device according to the invention are presented in FIG. 3. When the operator starts the sampling process, he positions the pipetting device in the source container of the specimen to be sampled. In step 60, he then presses the sampling control pushbutton. It follows that the image acquisition device then takes a photo of the source container's identifying means. The image acquired is placed in memory in step 62. This recording is carried out directly in the pipetting device if the latter has a storage means or in the memory of the computer of the analysis automaton. The image is analyzed in step 64. If the pipetting device has a microcontroller able to perform the analysis of the image, the microcontroller then attempts to recognize the identifier, lying on the image in step 66. For example, if the image is that of a barcode, the microcontroller attempts to recognize the value associated with the barcode. At this stage, either the microcontroller recognizes the identifier and the corresponding value is placed in memory, or the microcontroller does not recognize the identifier and in this case, the order is given to the image acquisition device to take a new photo for recognition of the identifier, in accordance with step 62. The previously taken image is then deleted.

These steps necessary for the recognition of the identifier can be reproduced as many times as necessary. However, provision may advantageously be made to determine a limited number of attempts at recognizing the identifier. The number of attempts can also be limited by limiting the time allocated to the recognition of the identifier. What matters in all cases is that the acquisition frequency is high, that is to say the time necessary for the acquisition of the image and the time necessary for the processing of the data, are the smallest possible.

The pipetting device must be able to offer a high rate of recognition of the identification means. Additionally, in the case where recognition of the identification means is impossible, the device is able to determine the cause of this non-recognition, doing so by way of the data processing algorithm. The errors preventing recognition of the identification means are:
an excessive inclination of the pipetting device, so that the image acquired is found to be unduly deformed;
wrong ambient lighting (over-exposure or under-exposure) so that the contrasts are too high or too low;
identification means unreadable, due for example to the fact that the identification means is impaired or hidden;
identification means outside of the reading field of the image acquisition means.

In order to improve the process for recognizing the identification means, it can be advantageous to integrate an accelerometer or a gyroscope into the pipetting device. This may for example be the accelerometer referenced MMA7260Q and marketed by the company Freescale Semiconductor, Inc. Specifically, such a device makes it possible to determine the angle of inclination of the pipetting device, concomitantly with image acquisition. Therefore, the acquired image is automatically related to the inclination measurement carried out. Thus, during the comparison of the data, the acquired image is compared only with images to which an equivalent value of inclination of the pipetting device is related. This makes it possible to substantially accelerate the step of recognizing the identifier, insofar as only the relevant data, contained in the reference database, are taken into account.

In the case where the identifier is not recognized, the operator is requested to perform the necessary corrective operations. These corrections are requested by way of the MMI. Once the corrections have been performed, the operator starts a new sampling procedure in the source container. If this turns out to be fruitless because of the non-identification of the source container, the operator then has the possibility of switching to non-assisted and non-monitored mode of the pipetting device. This mode consists in isolating the mechanical part of the pipetting device from any monitoring ancillary. Stated otherwise, the pipetting device then becomes a simple motorized pipette. In this case, the item of information of the switch to this “degraded” mode is recorded in the computer of the analysis automaton with a view to traceability. Alternatively, this item of information can be recorded in the pipetting device itself, if the latter has the appropriate storage means.

When the identifier is correctly recognized, the corresponding value is transmitted to the computer of the analysis automaton via the wireless transmission system of the pipetting device, during step 68. The data are then received by the wireless transmission system of the computer of the analysis automaton, in step 70. In step 72, the computer then compares the data received with those contained in the work list. This information saved by the operator in the computer, prior to the analysis, relates to all the data pertaining to the analysis to be carried out, such as for example the analyte to be searched for in the specimen, the reagents to be used in the course of the analysis, the volumes of reagents or specimens to be sampled and dispensed, the data related to the identification of the patients for whom the analysis must be carried out.

Two typical case can then occur in step 74: either the result of the comparison with the previous step makes it possible to identify the source container, that is to say the value obtained on the basis of the image taken by the image acquisition device was able to be correlated with the information contained in the work list; or the result of the comparison does not make it possible to identify the source container, namely that the value obtained on the basis of the image taken by the image acquisition device was not able to be correlated with any item of information contained in the work list.

In the case where the source container is identified as being appropriate to the analysis carried out, the computer of the analysis automaton provides the operator with information by means of the man-machine interface, in step 76. This information is related in particular to the sampling to be carried out, such as for example the volume of the specimen to be sampled in the source container. Other information provided to the operator by way of the man-machine interface can relate to the destination container, so as to guide the operator in respect of the dispensing step. In step 78, the computer of the analysis automaton transmits the sampling authorization and the corresponding information such as the volume to be sampled to the pipetting device by way of its wireless transmission system. Once this information has been received by the wireless transmission system of the pipetting device in step 80, it is displayed on the screen of the pipetting device in step 82. It is in particular possible to remind the operator of the volume which will be sampled. The pipetting device then samples the specified volume from the source container, in step 84.

In the case where the source container is not identified or in the case where it is identified but considered to be not in accordance with the analysis in progress, the operator is informed thereof by the computer by way of the man-machine interface, in step 86. Alarms are also activated so as to ensure that the operator has indeed been alerted. In step 88, the computer of the analysis automaton then transmits to the pipetting device by way of its wireless transmission system, the sampling prohibition and the corresponding information such as the alarms having to be activated on said device; these data are received in step 90 by the wireless transmission system of the pipetting device. The latter then takes over from the computer of the analysis automaton so as to display the alarms in step 92, then the disabling of said analysis automaton occurs in step 94.

The operator must then take the corrective measures in order that the sampling method be appropriate to the information contained in the work list, such as the changing of the source container if the latter is not the correct one.

According to an alternative of this sampling method, it is possible for the recognition of the identifier to be carried out directly by the computer of the analysis automaton. In this case, the raw image is transmitted by the pipetting device to the computer via their respective wireless transmission system. The image analysis and identifier recognition steps are then carried out within the computer of the analysis automaton. In the case where the identifier is recognized, the corresponding value is compared with the work list, in accordance with step 72 of the method described above. The steps which follow are then identical to those described above. On the other hand, if the identifier is not recognized, the computer transmits to the pipetting device the order to take a new picture. The method then restarts in the step of acquiring the image. The same limits as those given to the pipetting device, in terms of number of pictures or duration allocated to this step, can be given to the computer of the analysis automaton.

Once the specified volume has been sampled by the pipetting device, the operator can be invited by the computer of the analysis automaton to be carry out the next step of the analysis, namely the dispensing of the specimen. Thus, information on the destination container or containers of the sampled specimen can be provided to the operator by way of the man-machine interface.

The dispensing step or steps can then proceed in accordance with FIG. 4.

When the operator starts the dispensing process, he positions the pipetting device in the destination container of the specimen to be dispensed or one of the containers if the sampled volume must be dispensed into several destination containers (carrying out of aliquots or of several analyses in parallel). In step 160, he then presses the dispensing control pushbutton which may be the same button as the sampling control pushbutton or another pushbutton. This results in the taking of a picture of the destination container, by the image acquisition device, at the level of said destination container's identifying means. The image acquired is placed in memory in step 162. This recording is carried out directly in the pipetting device if the latter has a storage means or in the memory of the computer of the analysis automaton. The image is analyzed in step 164. The microcontroller of the pipetting device then attempts to recognize the identifier lying on the image in step 166. For example, if the image is that of a barcode, the microcontroller attempts to recognize the value associated with the barcode. The identifier can also be an acronym or an alphanumeric code. According to a third variant, the identifier can be a color code.

Thus, if the analysis automaton is a VIDAS®, the destination container consists of a consumable comprising a cartridge with several reservoirs intended for the analysis. Such a cartridge is represented in FIG. 5A, under the reference 200. A view in enlargement of one of the ends of the cartridge, represented in FIG. 5B, shows the various elements allowing the identification of said cartridge. Thus, it is noted that the cartridge 200 comprises first of all a sticker 202, generally of determined color, bearing the acronym corresponding to the analysis that said cartridge makes it possible to carry out. It is noted that this acronym 204 is repeated on the cartridge in a larger size and in a black on white format, so as to facilitate its reading. Finally, the cartridge furthermore comprises an alphanumeric code 206, which is the unique code making it possible to identify each cartridge. When the operator dispenses the specimen into said cartridge by virtue of the pipetting device, it is essential that the latter can ensure that the dispensing is done into the correct cartridge, namely the cartridge corresponding to the desired analysis. Moreover, it is important to be able to acquire the data identifying the cartridge itself.

At this stage, either the microcontroller recognizes the identifier and the corresponding value is placed in memory, or the microcontroller does not recognize the identifier and in this case, the order is given to the image acquisition device to take a new photo for recognition of the identifier, in accordance with step 162. In the case where the container is a VIDAS® cartridge, the pipetting device must be able to recognize at least one of the two identifiers of the analysis carried out with the cartridge (color code or acronym), as well as the identifier of the cartridge itself (alphanumeric code). It must also be able to determine in which well of the cartridge the pipetting device is positioned.

These steps necessary for the recognition of the identifier can also be repeated as many times as necessary. However, here again it will be advantageous to envisage limiting the number of attempts at recognizing the identifier or the time allocated to the recognition of the identifier. What also matters is that the acquisition frequency is high, that is to say the time necessary for the acquisition of the image and the time necessary for the processing of the data, are the smallest possible.

In the case where the identifier is not recognized, the operator is requested to perform the necessary corrective operations. These corrections are requested by way of the MMI. Once the corrections have been performed, the operator starts a new procedure of dispensing into the destination container. If this turns out to be fruitless because of the non-identification of the source container, the operator then has the possibility of switching to non-assisted and non-monitored mode of the pipetting device. In this case, the item of information of the switch to this “degraded” mode is recorded in the computer of the analysis automaton. Alternatively, this item of information can be recorded in the pipetting device itself, if the latter has the appropriate storage means.

When the identifier is correctly recognized, the corresponding value is transmitted to the computer of the analysis automaton via the wireless transmission system of the pipetting device, during step 168. The data are then received by the wireless transmission system of the computer of the analysis automaton, in step 170. In step 172, the computer then compares the data received with those contained in the work list.

Two typical cases can then occur in step 174: either the result of the comparison with the previous step makes it possible to identify the destination container, that is to say the value obtained on the basis of the image taken by the image acquisition device was able to be correlated with the information contained in the work list; or the result of the comparison does not make it possible to identify the destination container, namely that the value obtained on the basis of the image taken by the image acquisition device was not able to be correlated with any item of information contained in the work list.

In the case where the destination container is identified as being appropriate to the analysis carried out, the computer of the analysis automaton provides the operator with information by virtue of the man-machine interface, in step 176. This information relates in particular to the volume of the specimen to be dispensed into the destination container. In step 178, the computer of the analysis automaton transmits the dispensing authorization and the corresponding information such as the volume to be dispensed to the pipetting device by way of its wireless transmission system. Once this information has been received by the wireless transmission system of the pipetting device in step 180, it is displayed on the screen of the pipetting device in step 182. It is in particular possible to remind the operator of the volume which will be dispensed. The pipetting device then dispenses the specified volume into the destination container, in step 184.

In the case where the destination container is not identified or in the case where it is identified but considered to be not in accordance with the analysis in progress or the step of the analysis in progress, the operator is informed thereof by the computer by way of the man-machine interface, in step 186. Alarms are also activated, so as to ensure that the operator has indeed been alerted. In step 188, the computer of the analysis automaton then transmits to the pipetting device by way of its wireless transmission system, the dispensing prohibition and the corresponding information such as the alarms having to be activated on said device; these data are received in step 190 by the wireless transmission system of the pipetting device. The latter then takes over from the computer of the analysis automaton so as to display the alarms in step 192, then the disabling of said analysis automaton occurs in step 194.

The operator must then take the corrective measures in order that the dispensing method is appropriate to the information contained in the work list.

According to an alternative of this dispensing method and in a manner analogous to the sampling method described above, the recognition of the identifier can be carried out directly by the computer of the analysis automaton.

According to a variant of the dispensing method specific to the VIDAS®, the pipetting device must be able to identify not only the destination container consisting of the VIDAS® cartridge, but also the VIDAS® cone also specific to the analysis to be carried out and constituting the support of the immunological reaction and allowing the sampling of the reagents contained in the cartridge. Specifically, this dual identification must make it possible to ensure that the cartridge and the cone, disposed plumb with said cartridge, are indeed concordant.

According to another variant of the invention, the steps of image analysis and identifier recognition, and also of container identification by comparing with the work list can be carried out directly by the pipetting device. In this case, an important number of the functions necessary for this identification are loaded into the pipetting device. Thus, the software making it possible to operate the pipetting device, the work list, the data and/or image processing algorithm, the database of the acronyms and/or identification codes are loaded into the memory of the pipetting device which must be of a capacity and speed that are sufficient to ensure proper operation of the device. The function of the system for transmission between the pipetting device and the analysis automaton is then only to allow the transfer of information once the identification process has been finalized and the sampling or the dispensing performed, so that the automaton can start or continue the analysis of the specimen. Additionally, the information inherent to sampling or dispensing is stored in the analysis automaton or the computer of the latter for traceability purposes.

It emerges from the description given above, that the pipetting device according to the invention makes it possible to ensure the total traceability of the operations carried out in the course of an analysis. For all that, this total traceability does not limit the versatility of the pipetting device according to the invention.

Indeed, it can be used with the sole aim of saving the pipetting information (sampling and dispensing), without influencing these pipetting steps. In this case, the operator will not be guided while carrying out the analysis. On the other hand, in the event of errors during this analysis, it will be possible to refer to the saved data so as to identify the step during which the error was made.

It can also be used in “fully automatic” mode. In this case, all the pipetting steps are validated beforehand by the pipetting device itself or the computer of the analysis automaton, with which it is associated. Thus, in the event of error, the sampling or dispensing step is rendered impossible, until a corrective action is carried out.

1. An automatic pipetting device for a liquid specimen, essentially comprising:
a) at least one means for sampling-dispensing the liquid specimen;
b) at least one compartment for receiving the liquid specimen, intended to receive all or part of the liquid specimen sampled by said sampling-dispensing means;
c) at least one data acquisition means;
d) at least one data processing means integrated within said pipetting device or delocalized, able to process the data acquired by the data acquisition means;
e) at least one means for communication between the pipetting device and a data retrieval device, said communication means being able to transfer the data between said data acquisition means and said data processing means, when the latter is delocalized; and
f) at least one power supply means;
said device wherein the data acquisition means is a means for identifying the liquid specimen and/or the container or containers intended to receive all or part of said liquid specimen.

2. The device as claimed in claim 1, which furthermore comprises a data storage means.

3. The device as claimed in claim 1, in which the communication means is a wire-based connection means.

4. The device as claimed in claim 1, in which the communication means is a wireless transmission means.

5. The device as claimed in claim 4, in which said wireless transmission means is a device for sending-receiving radioelectric waves.

6. The device as claimed in claim 1, which furthermore comprises at least one information display means.

7. The device as claimed in claim 6, in which the information display means is a liquid crystal screen.

8. The device as claimed in claim 1, which the data acquisition means is an image acquisition means.

9. The device as claimed in claim 1, in which the means for sampling-dispensing the liquid specimen has a variable sampling capacity.

10. The device as claimed in claim 9, in which the sampling-dispensing means is of syringe type, comprising a body and a piston, said piston being propelled by an actuation means.

11. The device as claimed in claim 1, furthermore comprising a means for determining the angle of inclination of said device, during the implementation of said device.

12. The device as claimed in claim 11, in which the means for determining the angle of inclination of said device is an accelerometer or a gyroscope.

13. The use of a pipetting device as claimed in claim 1, for carrying out an analysis of a biological specimen.

14. A method for sampling a liquid specimen disposed inside a source container, with the aid of the pipetting device as claimed in claim 1, comprising the steps consisting in:
a) acquiring the identification data disposed on said source container, with the aid of the data acquisition means; and
b) sampling a determined volume of liquid specimen, with the aid of the sampling-dispensing means, in such a way that the volume of specimen sampled lies inside the compartment for receiving the liquid specimen.

15. A method of dispensing into a destination container, a liquid specimen contained in the compartment for receiving the liquid specimen of the pipetting device, as claimed in claim 1, comprising the steps consisting in:
a) acquiring the identification data disposed on said destination container, with the aid of the data acquisition means; and
b) dispensing into said destination container, all or some of the volume of liquid specimen contained in the reception compartment, with the aid of the sampling-dispensing means.

16. The method as claimed in claim 14, in which steps a) and b) are carried out simultaneously.

17. The method as claimed in claim 14, in which step b) is carried out prior to step a).

18. The method as claimed in claim 14, comprising an additional step of identifying the source container, consisting in:
transmitting the data acquired to the data processing systems and
comparing the transmitted data with a reference database, comprising identification data;
said additional step being able to be carried out before or after the sampling step b).

19. The method as claimed in claim 14, comprising an additional intermediate step a′) of validating the sampling step consisting in:
transmitting the data acquired to the data processing system,
comparing the transmitted data with a reference database, comprising identification data, by way of the data processing means, and
transmitting the sampling order to the sampling-dispensing means, when the source container has been correctly identified.

20. The method as claimed in claim 19, in which the volume of liquid specimen to be sampled is determined by the data processing means.

21. The method as claimed in claim 15, comprising an additional step of identifying the destination container, consisting in:
transmitting the data acquired to the data processing system; and
comparing the transmitted data with a reference database, comprising identification data;
said additional step being able to be carried out before or after the dispensing step b).

22. The method as claimed in claim 15, comprising an additional step a′) of validating the dispensing step consisting in:
transmitting the data acquired to the data processing system,
comparing the transmitted data with a reference database, comprising identification data, by way of the data processing means, and
transmitting the dispensing order to the sampling-dispensing means, when the destination container has been correctly identified.

23. The method as claimed in claim 22, in which the volume of liquid specimen to be dispensed is determined by the data processing means.

24. The method as claimed in claim 18, in which the steps consisting in:
transmitting the data acquired to the data processing system,
transmitting the sampling order to the sampling-dispensing means, and/or
transmitting the dispensing order to the sampling-dispensing means,
are carried out by way of the communication means, when the data processing means is delocalized.

25. A method of biological analysis comprising at least one step consisting in the sampling method and/or at least one step consisting in the dispensing method, as claimed in claim 14.
